(19) United States
(12) Patent Application Publication
(10) Pub. No.: US 2026/0287500 A1
(43) Pub. Date: Sep. 24, 2026

(54) PRODUCTION SYSTEM WITH NEAR-INFRARED SPECTROMETER

(71) Applicant: ATLINE ApS, Kolding (DK)

(72) Inventor: Thomas Kniep Jørgensen, Kolding (DK)

(73) Assignee: ATLINE ApS, Kolding (DK)

(21) Appl. No.: 18/874,263

(22) PCT Filed: Jun. 12, 2023
(86) PCT No.: PCT/EP2023/065630

§ 371 Date: Dec. 12, 2024

(30) Foreign Application Priority Data
Jun. 22, 2022 (DK) PA202270336

(51) Int. Cl. G01N 21/3554; G01N 1/28; G01N 21/3563; G01N 21/359; G01N 35/04

(52) U.S. Cl. CPC G01N 21/3554; G01N 1/286; G01N 21/3563; G01N 21/359; G01N 35/04; G01N 2001/2866; G01N 2021/3572; G01N 2201/127

(57) ABSTRACT

A production system has a plurality of production lines in each of which a bulk product is conveyed. A sampling arrangement collects samples of bulk products from a plurality of sampling positions at least at each product line and provides the material to an optical analysis system with at least one near-infrared spectrometer. A controller has a data communication interface connecting with a spectrometer interface, and transfers data identifying the material sample to a spectrometer controller. The optical analysis system processes the analysis results using the identifying data and provides an analysis output to the controller. The controller controls operation of the production devices of the production lines in response to the output from the spectrometer.

### CROSS-REFERENCE TO RELATED APPLICATIONS

The present application is the National Phase entry of International Patent Application No. PCT/EP2023/065630, filed Jun. 12, 2023, which claims priority to Denmark Patent Application No. PA202270336, filed Jun. 22, 2022, the entire contents of both are hereby incorporated by reference into this application.

### TECHNICAL FIELD

The present invention relates to a production system comprising a plurality of production lines in each of which a bulk product is conveyed, a sampling arrangement for automated collection of material samples of product flows of bulk products for analysis with a near-infrared spectrometer.

### BACKGROUND

International patent application WO 2020/169622 discloses a production process in which a physical sample of a chemical substance used in the production process is analysed at a laboratory site and laboratory data from that analysis is employed generating a control signal for controlling the production process. This control signal closes a control loop for adjusting the process until the laboratory data shows compliance.

It is an object of the present invention to provide a cost-efficient manner of controlling a production process by means of a control loop based on analysis of contents of physical samples.

### SUMMARY

The present invention relates to a production system comprising a plurality of production lines in each of which a bulk product is conveyed, possible heated, extruded, dried or otherwise treated, a sampling arrangement for automated collection of material samples of product flows of bulk products from a plurality of sampling positions by means of automated sampling devices, the plurality of sampling positions comprising at least one sampling position of each of said product lines, and providing the material samples in separate sample containers to an optical analysis system of the production system, wherein the optical analysis system comprises at least one near-infrared spectrometer, control means having a data communication interface connecting with a data communication interface of the near-infrared spectrometer, wherein the control means is adapted for transferring data identifying the material sample of a sample container to the control means of the near-infrared spectrometer prior to conducting an optical analysis of the material sample in the sample container, the optical analysis system being arranged for conducting an optical analysis of the material sample in sample containers through a transparent bottom part of the sample container, process the analysis results using said data identifying the material sample and providing an analysis output accordingly to the control means, wherein the control means are adapted to control the operation of one or more production devices of the production lines in response to the received analysis output from the near-infrared spectrometer.

By such production system, in particularly one providing a sampling arrangement that is arranged for automated collection of material samples of product flows of bulk products from a plurality of sampling positions comprising at least one sampling position of each of said product lines, and providing said material samples to at least one near-infrared spectrometer, and arranging control means of the production system to control the operation of one or more production devices in response to the analysis output from the near-infrared spectrometer, a cost-efficient manner of controlling a production process is achieved in that material samples from a plurality of sampling positions in a plurality of product lines may be automatically collected, provided to the same optical analysis system and the analysis results are used to form a control loop of the production system.

It is known from the prior art, such as from international patent application WO 2020/094199 to obtain samples directly from the product process of bulk products, e.g. animal feed in pellet form, grain etc. in order to perform an automatic analysis for surveillance of the quality of the product. The samples are subjected to optical analysis, such as spectrographic analysis by e.g. Near-Infrared Reflection (NIR).

By the term production lines is understood separate lines of production devices though which a flow of material in the form of a bulk product is passed, which at the outlet of the production lines presents as a final product. The production devices may comprise e.g. a product mixer, an extruder, a product drying device and/or a product cooling device.

The bulk product may e.g. be in the form of a powder, grains or pellets, or it may be a liquid, a sludge or a slurry.

The automated sampling devices are devices to be arranged in the production lines for online sampling of the flow of the bulk product, typically in conducts or the like. Such sampling devices are disclosed in e.g. international applications WO 2012/083966 and WO 2009/092378, the disclosure of which are hereby incorporated by reference.

The separate sample containers are open-sided containers, where the open side is left for loading and unloading the material samples, and opposite the open side is the transparent bottom part, through which the material sample in the container may be analysed optically by means of the near-infrared spectrometers operating with Near-Infrared Reflection (NIR).

The data transferred to the near-infrared spectrometers for identifying the material sample of a sample container comprises information comprises data about the material sample, such as expected content range of moisture, of fat, of protein and/or other contents, which may be employed to convert the raw data from the infra-red scanning of the material sample through the transparent bottom part of the container into an analysis output, which contain very precisely determined measures of the material sample's content of e.g. moisture, protein, content of fat, hydrocarbons, carboxylic acids, amines or sucrose/-glycose. The data identifying the material sample may further comprise data indicating e.g. the production line, the sampling position, time of sampling, and/or a unique identification code, which can be included in the analysis output.

In a preferred embodiment of the invention, the near-infrared spectrometer is adapted to provide data indicative of the moisture content of the material sample in the analysis output, and the control means are adapted to control the operation of one or more production devices of the production lines in response to said moisture content. The moisture content may e.g. be used for controlling the amount of water added to a product mixer device of the production line of which the material sample is obtained, and/or the operation of a product drying device of that production line, such as the drying temperature, speed of drying air or the residence time of the bulk product in the product drying device.

Generally, the production devices which the control means are adapted to control in response to the received output comprises preferably one or more of: a product mixer device, a product drying device and a product cooling device.

The production system may further comprise at least one inline spectroscope for each of said product lines, the inline spectroscopes being arranged for analysis of a product flow of a bulk product of at least one inline analysis position of each of said product lines and provide an inline output to the control means accordingly, wherein the control means of the production system is adapted for providing received analysis output from the near-infrared spectroscope to the inline spectroscopes for calibration thereof. The inline spectroscopes are preferably adapted to conduct the analysis in the near-infrared spectre.

The advantage of the inline spectroscopes is that they provide the control means with operational information of the production system almost instantaneously with very little time delay, whereas the analysis output from the near-infrared spectrometers are received by the control means with more considerable delay but also with much more precise information regarding the contents of the bulk products. The inline spectroscopes are less precise, but the usability of the inline output to the control means is significantly improved when the calibration of the inline spectroscopes can be continuously improved and adjusted by means of the analysis output from the near-infrared spectroscopes. In particular, the control means may be adapted to control the operation of one or more production devices of the production lines in response to the received inline output from the inline spectroscopes.

The inline spectroscopes may in particular be adapted to provide data indicative of the moisture content of the material sample in the inline output, and wherein the control means are adapted to control the operation of one or more production devices of the production lines in response to said moisture content.

The production devices which the control means are adapted to control in response to the received inline output from the inline spectroscopes may in a preferred embodiment comprise one or more of: a product mixer device, a product drying device and a product cooling device.

The sampling arrangement may preferably be arranged to provide automatically collected material samples from more than one of the production lines and possibly from more than one sampling positions of each production line to same near-infrared spectrometer. Thereby, the one and same near-infrared spectrometer may be employed to analyse material samples obtained from a multitude of sampling positions in the different production lines. However, the production system may comprise only one near-infrared spectrometer, but it is not ruled out that the production system comprises more than one near-infrared spectrometer.

The sampling arrangement may further comprise a grinding system arranged for grinding material samples prior to placing the material sample in the sample container. This is particularly useful when the bulk material is in the form of grains or pellets, where a finer grinding of the material sample prior to the optical analysis of the material sample by means of the near-infrared spectrometer provides a more precise and homogeneous analysis and thereby analysis output from the near-infrared spectrometer.

The production system may further comprising weighing means arranged for weighing material samples prior to placing the material sample in the sample container so as to ensure that the material sample contains a sufficient amount of material to be analysed for a satisfactory outcome of the analysis, in particular to ensure that all of the transparent bottom part of the sample container is sufficiently covered by the material sample. The automated sampling devices may also or alternatively be adapted to collect a predefined volume of sample material in a material sample for the same reason.

The optical analysis system may further comprises a camera for recording images of an upper surface of a material sample in the sample container through an open side thereof for analysis thereof with respect to e.g. distribution of particle size and/or colour distribution of the particles of the material sample. The camera may preferably be arranged for detecting the height of the upper surface of the sample material in the sample container to determine whether the sample container is sufficiently filled with sample for the subsequent analysis.

The optical analysis system may further or alternatively to the camera comprise an ultrasound scanner arranged for scanning the upper surface of as material sample situated in a sample container for detecting the height of the upper surface of the sample material in the sample container.

The production system may further comprise a product sample packaging arrangement, and wherein the sampling arrangement is adapted for providing material samples collected by means of the sampling arrangement from the plurality of sampling positions to the product packaging arrangement, wherein the product packaging arrangement is adapted for providing sample packages with each individual material sample, and wherein the production system comprises control means adapted for transferring data identifying the material sample to a labelling arrangement for labelling said sample packages with the corresponding data identifying the material sample. Such sample packages may be used for later tracking and tracing of possible deviations in the production of the final bulk material.

The sampling arrangement may preferably be adapted for collection of a material sample and dividing that material sample in one material sample for the optical analysis system and another part for the product sample packaging arrangement. Hereby, an analysis output directly connected to a sample package is obtained for later tracking and tracing of the production of the final bulk material.

### BRIEF DESCRIPTION OF THE DRAWING

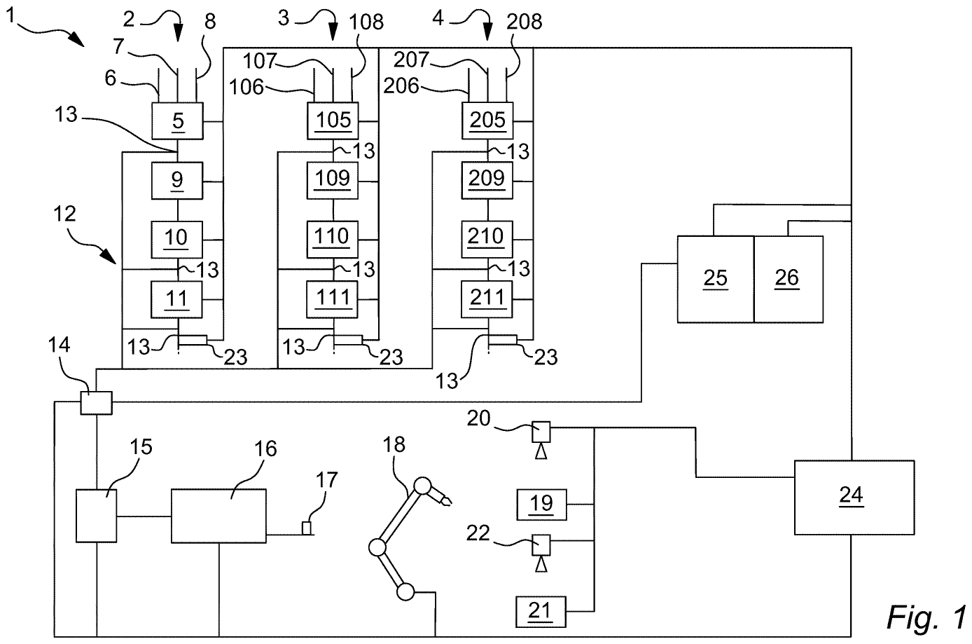

An example of a system according to the present invention is illustrated in the enclosed drawing of which FIG. 1 is a diagram of main part a production system.

The present invention is not limited to the features of the drawing, which is provided for supporting the understanding of the invention.

### DETAILED DESCRIPTION

A production system 1 is illustrated in FIG. 1 comprising three production lines 2, 3, 4 for a bulk product, such as dry food for animals provided as extruded pellets as the final product. However, production lines for other bulk products could be included alternatively or additionally.

Each production line 2, 3, 4 includes a mixer 5, 105, 205 each with an inlet for water, 6, 106, 206 and a first ingredient 7, 107, 207 and for a second ingredient 8, 108, 208. More inlets for ingredients for each mixer 5, 105, 205 could be envisaged.

From the mixers 5, 105, 205 the bulk product in the form of a paste or a moist mass is conveyed to extruders 9, 109, 209 where pellets are formed by extrusion and cutting. The pellets are dried by a hot air flow in the following dryers 10, 110, 210 where after the pellets are cooled in the coolers 11, 111, 211. The final bulk product in form of dried and cooled pellets are now ready for packaging (not shown). Each production line 2, 3, 4 is provided with a number of automated sampling devices situated at sampling position 13 after the mixers 5, 105, 205, after the dryers 10, 110, 210 and after the coolers 11, 111, 211, respectively. After the coolers 11, 111, 211 are also installed near-infrared inline sensors 23 for conducting a continuous monitoring of the contents of the final bulk product, such as moisture, content of fat or protein but also contents of hydrocarbons, carboxylic acids, amines or sucrose/-glycose may be monitored.

The automated sampling devices 13 are operated by the control system 24 to extract material samples of the bulk material flow to the sampling arrangement 12 which directs the material samples to the sample divider 14, which is operated by the control system 24 to direct the material sample to the grinder 15, to the packaging apparatus 25 or to divide the material sample between the grinder 15 and the packaging apparatus 25. The automated sampling devices 13 are adapted to collect a material sample of a predefined volume, e.g. by means of using a sampling cup which is filled to a predefined level a predefined number of times, e.g. one or two, in order to collect a material sample.

For material samples directed to the grinder 15, where the content of the material sample is grinded to a uniform fine-grained material that is suitable for the following NIR (Near-Infrared) spectroscopy. The mass of the material sample is found by means of the weight 15 to which the material sample is transferred from the grinder 15, and the determined mass is provided to the control system 24 in order to calculate the density of the material sample as the volume is fixed from the automated sampling device 13. In case the detected mass is outside of a predefined range, the material sample is discharged and a new sample from the same sampling position/automated sampling device 13 is requested from the control system 24. From the weight 16, the grinded material sample is loaded onto a sample container 17 having a transparent bottom part and a container handling apparatus in the form of a robotic arm 18 is arranged to transfer the sample container 17 to an analysis top-plate of one of the two Near-Infrared Spectrometers 19, 21, where an optical analysis of the contents of the sample container 17 by means of NIR through the transparent bottom part of the sample container 17 is conducted. Identification data for the material sample in question containing data for the interpretation of the analysis, such as the expected range of content of moisture, fat, protein etc. and/or other data used in the calibration and/or interpretation of the outcome of the analysis are transferred from the control system 24 of the production system 1 to the NIR Spectrometer 19, 21, and the analysis output is transferred back to the control system 24, the analysis output typically comprising data relating to the moisture content of the material sample and may also relate to the content of fat or protein, the contents of hydrocarbons, carboxylic acids, amines or sucrose/-glycose. The analysis output may be employed to control the operation of various production devices of the production system, such as the mixers 5, 105, 205, the dryers 10, 110, 210 and/or the coolers 11, 111, 211. Furthermore, the analysis output from the NIR Spectrometers 19, 21 may be employed to calibrate and/or adjust the Near-Infrared inline sensors 23 to achieve a more reliable input to the control system 24 from those, since the NIR Spectrometers 19, 21 obtain a more precise measure of the content of the analysed material sample, whereas the Near-Infrared inline sensors 23 have the advantage of providing online measurements of the content of the bulk material. When the sample container 17 is positioned for analysis on a top-plate of one of the two Near-Infrared Spectrometers 19, 21, a camera 20, 22 positioned with visual access to the top of the sample container 17 records or scans the top face of the material sample in the sample container 17 for analysis of physical properties, such as the particle size and size distribution of the material sample.

The control system 24 may apply the received analysis output from the NIR spectrometers 19, 21 and/or from the received inline output from the inline Near-Infrared inline sensors 23 to control the operation of one or more of the various production devices of the production system, such as the mixers 5, 105, 205, the dryers 10, 110, 210 and/or the coolers 11, 111, 211. The measured moisture content of the bulk material may be used to control the operation of the water inlets 6, 106, 206 of the mixers 5, 105, 205, i.e. by controlling the amount of water added to the mixture. It may additionally or alternatively be used to control the drying and/or cooling process by controlling the operation of the dryers 10, 110, 210 and/or the coolers 11, 111, 211 as both processes removes water from the final product.

For material samples directed by the sample divider 14 to the packaging apparatus 25, data identifying the material sample are transferred from the control system 24 to the labelling apparatus 26 so that a package of a material sample may be labelled by the labelling apparatus with an identification of e.g. production line 2, 3, 4, sampling position 13, time of sampling, end product type and/or other data, such as data from the analysis output from the NIR Spectrometer 19, 21 from an analysis of a corresponding material sample, in particular of a material sample divided by the sample divider 14 from the material sample in the package. Such packaged material samples may be useful for later tracking and tracing of possible deviations in the production of the final bulk material.

### LIST OF REFERENCE NUMBERS

1 Production system
2 First production line
3 Second production line
4 Third production line
5, 105, 205 Mixer
6, 106, 206 Water inlet for mixer
7, 107, 207 Inlet to mixer for first ingredients
8, 108, 208 Inlet to mixer for second ingredients
9, 109, 209 Extruder
10, 110, 210 Dryer
11, 111, 211 Cooler
12 Sampling arrangement
13 Sampling position with automated sampling devices
14 Sample divider
15 Grinder
16 Weight
17 Sample container
18 Container handling apparatus
19 First Near-Infrared Spectrometer
20 First camera
21 Second Near-Infrared Spectrometer
22 Second camera
23 Near-Infrared inline sensor
24 Control system
25 Packaging apparatus
26 Labelling apparatus

1. A production system comprising a plurality of production lines in each of which a bulk product is conveyed, comprising:
a sampling arrangement for automated collection of material samples of product flows of bulk products from a plurality of sampling positions by means of automated sampling devices, the plurality of sampling positions comprising at least one sampling position of each of said product lines, and providing the material samples in separate sample containers to an optical analysis system of the production system,
wherein the optical analysis system comprises at least one near-infrared spectrometer,
a controller having a data communication interface connecting with a data communication interface of the near-infrared spectrometer, wherein the controller is adapted for transferring data identifying the material sample of a sample container to a controller of the near-infrared spectrometer prior to conducting an optical analysis of the material sample in the sample container,
the optical analysis system being arranged for conducting an optical analysis of the material sample in sample containers through a transparent bottom part of the sample container, process the analysis results using said data identifying the material sample and providing an analysis output accordingly to the controller,
wherein the controller is adapted to control the operation of at least one production devices of the production lines in response to the received analysis output from the near-infrared spectrometer.

2. The production system according to claim 1, wherein the near-infrared spectrometer is adapted to provide data indicative of the moisture content of the material sample in the analysis output, and wherein the controller is adapted to control the operation of one or more production devices of the production lines in response to said moisture content.

3. The production system according to claim 1, wherein the production devices which the controller is adapted to control in response to the received output comprises one or more of: a product mixer device, a product drying device and a product cooling device.

4. The production system according to claim 1, further comprising at least one inline spectroscope for each of said product lines, the inline spectroscopes being arranged for analysis of a product flow of a bulk product of at least one inline analysis position of each of said product lines and provide an inline output to the controller accordingly, wherein the controller of the production system is adapted for providing received analysis output from the near-infrared spectroscope to the inline spectroscopes for calibration thereof.

5. The production system according to claim 4, wherein the inline spectroscopes are adapted to conduct the analysis in the near-infrared spectre.

6. The production system according to claim 4, wherein the controller is adapted to control the operation of one or more production devices of the production lines in response to the received inline output from the inline spectroscopes.

7. The production system according to claim 6, wherein the inline spectroscopes are adapted to provide data indicative of the moisture content of the material sample in the inline output, and wherein the controller is adapted to control the operation of one or more production devices of the production lines in response to said moisture content.

8. The production system according to claim 6, wherein the production devices which the controller is adapted to control in response to the received inline output from the inline spectroscopes comprises one or more of: a product mixer device, a product drying device and a product cooling device.

9. The production system according to claim 1, wherein the sampling arrangement is arranged to provide automatically collected material samples from more than one of the production lines to same near-infrared spectrometer.

10. The production system according to claim 1, wherein the sampling arrangement further comprises a grinding system arranged for grinding material samples prior to placing the material sample in the sample container.

11. The production system according to claim 1, further comprising weighing means arranged for weighing material samples prior to placing the material sample in the sample container.

12. The production system according to claim 1, wherein the automated sampling devices are adapted to collect a predefined volume of sample material in a material sample.

13. The production system according to claim 1, wherein the optical analysis system further comprises a camera for recording images of a surface of a material sample in the sample container.

14. The production system according to claim 1, further comprising a product sample packaging arrangement, and wherein the sampling arrangement is adapted for providing material samples collected by means of the sampling arrangement from the plurality of sampling positions to the product packaging arrangement, wherein the product packaging arrangement is adapted for providing sample packages with each individual material sample, and
wherein the production system comprises controller adapted for transferring data identifying the material sample to a labelling arrangement for labelling said sample packages with the corresponding data identifying the material sample.

15. The production system according to claim 14, wherein the sampling arrangement is adapted for collection of a material sample and dividing that material sample in one material sample part for the optical analysis system and another part for the product sample packaging arrangement.

16. The production system according to claim 9, wherein the sampling arrangement is arranged to provide automatically collected material samples more than one sampling positions of each production line to same near-infrared spectrometer.
